(19) United States
(12) Patent Application Publication
(10) Pub. No.: US 2003/0052764 A1
(43) Pub. Date: Mar. 20, 2003

(54) Noncontact transformer

(75) Inventors: Seiichi Iwao, Hikone shi (JP); Yoshinori Katsura, Hikone shi (JP); Mikihiro Yamashita, Echi-gun (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 10/235,645

(22) Filed: Sep. 6, 2002

(30) Foreign Application Priority Data
Sep. 14, 2001 (JP) 2001-280083

(51) Int. Cl. H01F 21/04

(52) U.S. Cl. 336/75

(57) ABSTRACT

A noncontact transformer installed on the floor of a housing whereby air entrapment within the resin that fills spaces in the transformer is prevented. A primary transformer component is provided on a lower surface of a primary housing, which is then filled with resin. Primary transformer component includes a core space which is defined by inclined internal wall that extends away from the lower surface to form a widely open end of the core space that is larger than the end at the lower surface.

### BACKGROUND OF THE INVENTION

1. Field of the Invention

The invention relates to a noncontact transformer in which electrical power is transmitted through a process of noncontact electromagnetic induction across a region defined by mutually opposing primary and secondary transformers.

2. Description of Related Art

FIG. 5 illustrates the structure of a conventional noncontact transformer T which includes a primary transformer 3 installed within primary housing 2, and secondary transformer 5 installed within secondary housing 4. The transformers are positioned in mutual opposition and are separable from each other. Electromagnetic inductance, which occurs between primary coil 8 of primary transformer 3 and secondary coil 9 of secondary transformer 5, induces noncontact electrical power transmission between primary transformer 3 and secondary transformer 5. Transformer T can, for example, be incorporated into an electrical appliance that is exposed to water such as an electric toothbrush or electric shaver shown as appliance X in the figure, and into charging device Y which is used to electrically charge appliance X. The noncontact transformer allows charging device Y to safely supply electricity to the terminals on appliance X, even when appliance X is wet, without a physical connection being established between appliance X and charging device Y. In order to bring primary transformer 3 and secondary transformer 5 into closest proximity to establish a high degree of electromagnetic induction efficiency for noncontact transformer T, primary transformer 3 and secondary transformer 5 are positioned at the internal sides of the opposing surfaces of primary housing 2 and secondary housing 4, respectively. In order to reduce manufacturing costs, ferrous cores are not installed in core space 1 of primary transformer 3 and secondary transformer 5. Once the primary housing has been specified in relation to charging device Y, primary housing 2 is filled with resin 6 (FIG. 6) which completely surrounds primary transformer 3 to seal out water and improve heat dissipation.

The prior art has many shortcomings and disadvantages. For example, in cases where resin 6 is used within primary housing 2, resin 6 is poured into the internal area of primary housing 2 opposing lower surface 2a which faces secondary housing 4. In order that primary transformer 3 is completely immersed within resin 6, resin 6 must enter core space 1 of primary transformer 3. When resin 6 is poured into core space 1 of primary transformer 3, the air present within core space 1 must have a means of escape to allow the complete inflow of resin 6. Lower surface 2a of primary housing 2 forms the closed end of core space 1, and because the narrow open end of core space 1 is small, a dead end passage is formed that makes it difficult for air to escape from the aforesaid narrow open end which in turn makes it difficult for resin 6 to fill primary transformer core space 1. When resin 6 flows into primary transformer core space 1, the air at floor 1a cannot escape, thus resulting in residual air 15 remaining within resin 6 (FIG. 6). The continual operation of primary transformer 3 generates heat that causes residual air 15 trapped within resin 6 to expand with the result that primary housing 2 may crack or distort.

### SUMMARY OF THE INVENTION

The present invention addresses and resolves air entrapment problems discussed above via, among other things, a noncontact transformer that does not trap air in the hollow transformer core when filled with resin, even though the bottom surface of a housing is attached to the transformer.

The noncontact transformer of the present invention incorporates a primary transformer component installed within a primary housing which is located opposite to a secondary transformer component installed within a secondary housing. As a result of the electromagnetic induction occurring between the primary coil of the primary transformer component and the secondary coil of the secondary transformer component, electrical power is transmitted between the primary transformer component and the secondary transformer component with no physical connection established between the two transformer portions. The primary transformer component is installed within the primary housing which internal area is filled with resin, one extremity of the primary transformer component is attached to a lower surface in the primary housing, and a core space of the primary transformer component is defined by an inclined internal wall that extends outward from the lower surface to form a widely open end of the core space that is larger than the end at the lower surface. As the widely open end of the core space is larger than the closed end at the lower surface, air within the core space is allowed to escape from the side of the core space when resin is poured in, thus making it possible for resin to fill the core space without trapping residual air (see FIG. 6). Furthermore, because the core space incorporates the internal inclined wall, resin flows smoothly into the core space along the aforesaid inclined surface toward the floor, and air within the core space flows out smoothly before the core becomes filled with resin, thus establishing a mechanism able to prevent the entrapment of residual air within resin that fills the core space.

The noncontact transformer of the present invention is further characterized by the coil of the primary transformer component being wound around a cylindrical wall parallel to the axial center of the primary transformer component. This structure, in which the primary coil is wound around the external wall of a cylindrical element formed parallel to the axial center of the primary transformer component, simplifies the wire winding operation through which the coil is attached to the primary transformer component. This structure is provided to simplify the manufacturing operation by making the transformer more adaptable to a mass production process.

The noncontact transformer of the present invention is further characterized by a number of step portions formed to various diameters within the core space of the primary transformer component, the step portions being located at levels of gradually increasing diameter extending from the floor of the primary housing of the primary transformer component to the widely open end of the core space. The installation of the step portions within the core space decreases the speed with which resin flows from the widely open end to the bottom of the core space, thus allowing more time for the air in the core space to escape from the widely open end to the exterior region and thus preventing the entrapment of residual air within resin that fills the core space.

The noncontact transformer of the present invention is further characterized by open bores that pass through the primary transformer component from a cylindrical surface to connect to the core space wherein open bores are formed with an internal diameter smaller than that of the core space. This structure, in which resin fills the area between the primary housing and the primary transformer component, allows resin to slowly flow into the core space through open bores which are formed to a smaller diameter than the internal diameter of the core space, allows residual air trapped within resin to escape from resin which fills the core space, and further prevents residual air from being entrapped within the resin which fills the core space.

An aspect of the present invention provides a noncontact transformer including a primary transformer component provided within a primary housing and a secondary transformer component provided within a secondary housing, the transformer components being oriented in mutual opposition to induce noncontact electrical power transmission between the primary transformer component and the secondary transformer component through respective primary and secondary coils, wherein the primary transformer component is attached to a lower surface of the primary housing and is immersed in resin filling the primary housing, the noncontact transformer including an inclined internal wall defining a core space within the primary transformer component, the inclined internal wall extending from the lower surface of the primary housing to an open end, the open end larger than a portion of the core space at the lower surface of the primary housing.

According to a further aspect of the present invention, the primary transformer component includes a cylindrical surface parallel to the axis of the primary transformer component, and the primary coil of the primary transformer component includes electrical wire wound around the cylindrical surface. Further, the noncontact transformer may include a plurality of stepped portions provided at various diameters within the core space of the primary transformer component, the stepped portions located at specific distances at points of wider opening extending from the lower surface of the primary housing of the primary transformer component to the open end of the core space.

Further, a plurality of open bores may be provided within the primary transformer component, each of the plurality of open bores extending from a cylindrical surface to connect to the core space, each of the open bores having a diameter less than a diameter of the core space. The portion of the core space at the lower end of the primary housing may define a floor having a diameter A and the open end of the core space may define a widely open end having a diameter B, so that: B>A. Further, the inclined internal wall of the core space may be configured substantially in a cone shape extending from the lower surface of the primary housing with an increasing diameter toward the open end.

According to a further aspect of the present invention, the noncontact transformer may include a plurality of stepped portions provided at various diameters within the core space of the primary transformer component, the stepped portions located at specific distances at points of wider opening extending from the lower surface of the primary housing of the primary transformer component to the open end of the core space. Each of the plurality of stepped portions may have a height dimension parallel to the axial direction of the primary transformer component of D, so that: D≦(B−A)/4. Further, each of the plurality of stepped portions may have a dimension perpendicular to the axial direction of the primary transformer component of C, the primary transformer component may have a height E in the axial direction of the primary transformer component, and the lower surface of the primary housing and the primary coil may be separated by a distance F, so that: C≦(E−F)/2.

In a further aspect of the present invention, each of the plurality of open bores may include an internal wall forming a first angle a with the lower surface of the primary housing and the inclined internal wall defining the core space may form a second angle β with the lower surface of the primary housing, so that: 0<α<β. Further, each of the plurality of open bores may extend from an external cylindrical surface of the primary transformer component through the primary transformer component toward the lower surface of the primary housing and to the core space, so that each of the plurality of bores is slanted downwardly toward the lower surface of the primary housing. Further, each of the plurality of open bores may extend radially from an external cylindrical surface of the primary transformer component through the primary transformer component toward the center of the core space.

A further aspect of the present invention includes a primary transformer component for a noncontact transformer, the primary transformer component attached to a lower surface of a primary housing and including a primary coil, the primary transformer component including an inclined internal wall defining a core space within the primary transformer component, the inclined internal wall extending from the lower surface of the primary housing to an open end, the open end larger than a portion of the core space at the lower surface of the primary housing. Further, the primary transformer component may be immersed in resin filling the primary housing.

A further aspect of the present invention provides, in combination, a rechargeable electric appliance; a noncontact transformer; and a primary transformer component.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is an elevational cross-sectional view of a portion of the noncontact transformer according to one embodiment of the present invention;

FIG. 2 is an elevational cross-sectional view of a portion of the noncontact transformer according to a second embodiment of the present invention;

FIG. 3 is an elevational cross-sectional view of a portion of the noncontact transformer according to a third embodiment of the present invention;

FIG. 4 is an elevational cross-sectional view of a portion of the noncontact transformer according to a fourth embodiment of the present invention;

FIG. 5 is an elevational cross-sectional view of a conventional noncontact transformer; and

FIG. 6 is an elevational cross-sectional view of the conventional noncontact transformer of FIG. 5 filled with resin.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

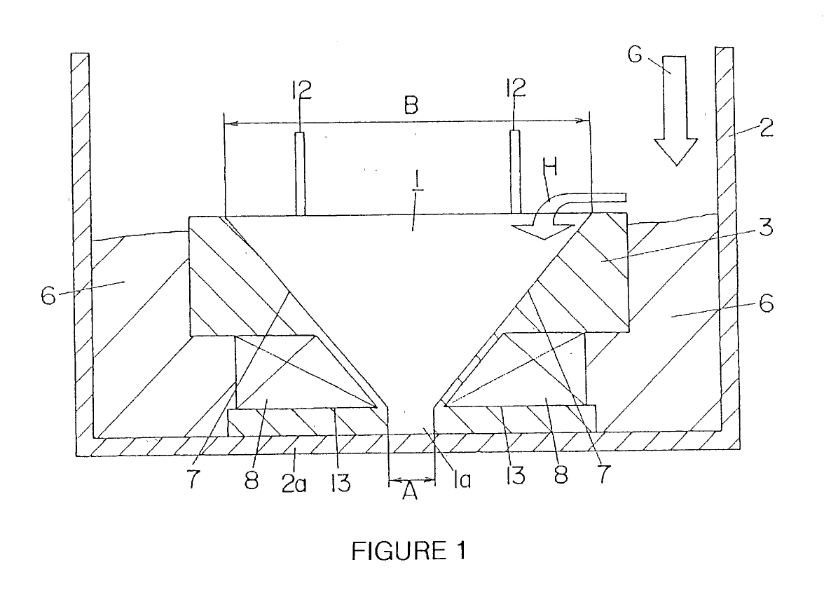

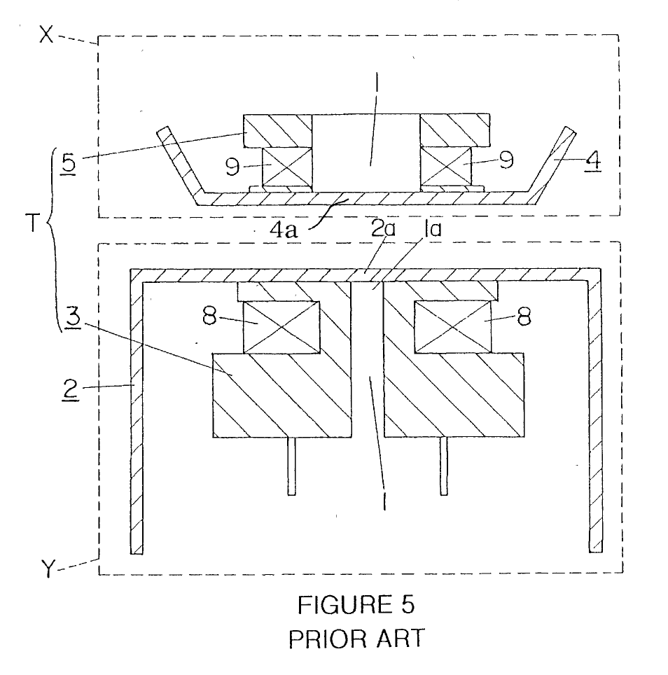

FIG. 1 illustrates a noncontact transformer according to the first embodiment of the present invention. FIG. 1 shows the relationship between primary housing 2 and primary transformer component 3 that form a portion of noncontact transformer T. Like elements are denoted by the same reference numerals as in FIG. 5. Noncontact transformer T is formed of primary transformer component 3 within primary housing 2 oppositely facing secondary transformer component 5 within secondary housing 4 (which are not shown in FIG. 1). A noncontact electrical power transmission effect is obtained between primary transformer component 3 and secondary transformer component 5 as a result of electromagnetic inductance that occurs between primary coil 8 in primary transformer component 3 and secondary coil 9 in secondary transformer component 5. This noncontact electrical power transmission effect can be made use of by installing one portion of noncontact transformer T in an electrical appliance that is exposed to water, such as, for example, an electric toothbrush or electric shaver, shown as appliance X in FIG. 5, and in charging device Y which is used to electrically charge appliance X.

This embodiment includes noncontact transformer T as a component of a water exposed electric appliance X and also as a component of a charging device Y that is used to electrically charge appliance X. Therefore, in this case, primary housing 2 becomes the charging device housing, primary transformer component 3 becomes the charging device transformer, secondary housing 4 becomes the electrical appliance housing, and secondary transformer component 5 becomes the electrical appliance transformer.

Primary transformer component 3 and secondary transformer component 5, which together form noncontact transformer T, are formed as respective cylindrical bodies each incorporating core space 1 which includes a central void region formed within each of the two cylindrical bodies. Each cylindrical body is equipped with a wire coil formed from wire wound around a portion of each cylindrical body. Primary transformer component 3 and secondary transformer component 5 are located in mutual opposition with end faces of each cylindrical body being mutually opposed and with the center axis of each core space 1 being mutually aligned on the same linear axis. Furthermore, channel 13 is provided as a coil housing space located in the proximity of the opposing end faces of the cylindrical bodies. To be more specific, channel 13 extends radially from a cylindrical wall portion of the cylindrical body in order to provide a space within which electrical wire can be wound to form the coil. The coil portion of primary transformer component 3 is termed primary coil 8, and the coil portion of secondary transformer component 5 is termed secondary coil 9. Electricity passing through primary coil 8 can be transmitted to secondary coil 9 through an electromagnetic induction effect. That is, electrical power is transmitted between primary coil 8 and secondary coil 9 without any physical connection. In this embodiment, primary coil 8 and secondary coil 9 are in proximity to each other between primary transformer component 3 and secondary transformer component 5. Because primary coil 8 and secondary coil 9 are in proximity to each other, a structure is formed that prevents a fall-off in the electrical transmission efficiency of noncontact transformer T. Reference numeral 12 denotes the terminals that connect to wire leads or a printed circuit board to supply electrical power to primary coil 8. Although primary transformer component 3 and secondary transformer component 5 are installed within primary housing 2 and secondary housing 4, respectively, the distance between primary transformer component 3 and secondary transformer component 5 can be reduced to a minimum by placing lower surface 2a of primary housing 2 against lower surface 4a of secondary housing 4 when the cylindrical end faces of primary transformer component 3 and secondary transformer component 5 are placed in mutual opposition.

In regard to the shape of core space 1, core space 1 extends from lower surface 2a of primary housing 2, which is attached to primary transformer component 3, to the widely open end portion which is larger than the portion of core space 1 at lower surface 2a . If the diameter of floor 1a of core space 1 is termed A, and the diameter of the widely open end of core space 1 is termed B, the relationship between A and B can be expressed as B>A. In this embodiment, inclined wall 7, as shown in FIG. 1, defines the internal wall of core space 1 which extends from lower surface 2a of primary housing 2 with an increasing diameter in the axial direction. In other words, core space 1 is formed as an approximate cone shape as it extends upward toward the widely open end of the core space 1.

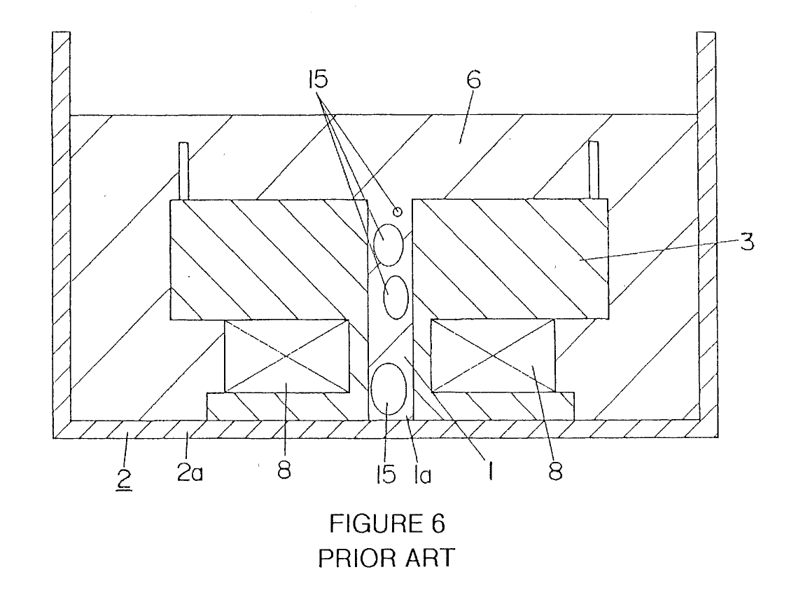

In regard to the method of securing primary transformer component 3 within primary housing 2, the internal area of primary housing 2 is completely filled with resin 6 similar to the conventional method. With lower surface 2a of primary housing 2 defining the bottom of a container shape, when resin 6 is poured into primary housing 2, resin 6 fills the outer cylindrical portion of primary transformer component 3 between transformer 3 and primary housing 2 (arrow G). In regard to the process through which primary transformer component 3 is embedded in resin 6, when primary transformer component 3 becomes completely immersed in resin 6, core space 1 also becomes filled with resin 6. That is, resin 6 first fills the area between the outer cylindrical part of primary transformer component 3 and primary housing 2, spills over into the widely open end of core space 1, and then gradually fills core space 1 (arrow H). In this embodiment, core space 1 is an approximate cone shape with the widely open end of the cone located at the top. Because core space 1 has a widely open end from which inclined internal wall 7 moves downward toward the smaller end, resin 6 is able to flow smoothly down inclined internal wall 7, from the widely open end toward floor 1a , while at the same time allowing air to escape from core space 1. The entrapment of residual air 15 in the prior art device depicted in FIG. 6 within resin 6 in core space 1 is prevented when resin 6 fills the type of cone-shaped core space of the present invention described above. As a result of primary transformer component 3 being immersed within resin 6 (which fills the internal area of primary housing 2) without the inclusion of residual air 15, the effect whereby the expansion of residual air 15 cracks resin 6 or distorts or damages primary housing 2 is eliminated even in the presence of heat generated by the operation of primary transformer component 3.

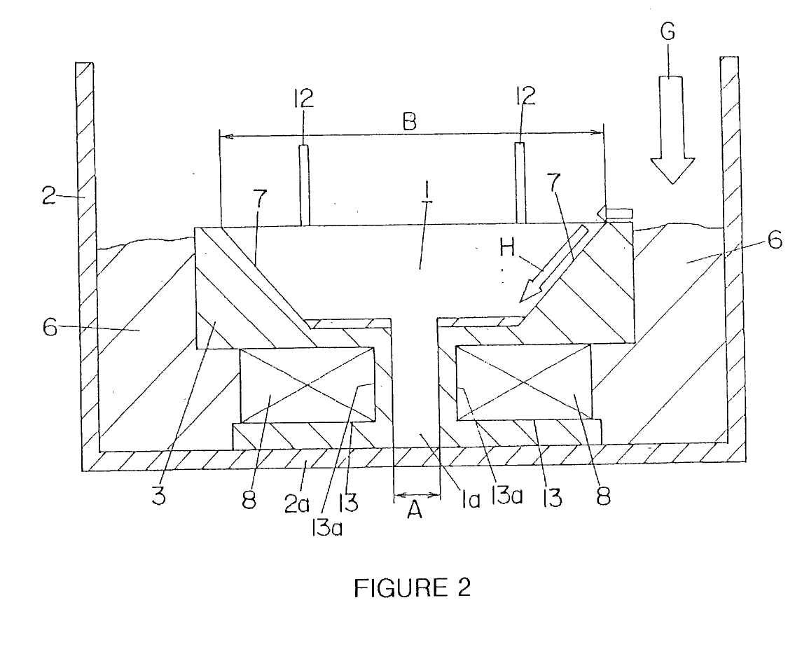

A second embodiment of the present invention is characterized by a modified shape of the primary transformer component 3. The following explanation refers only to the modified portions of the second embodiment, and does not cover similar structures that have already been explained in the previous embodiment. FIG. 2 illustrates the second embodiment which incorporates a cylindrical wall 13a, formed parallel to the axial centerline of primary transformer component 3, around which electrical wire is wound to form primary coil 8. That is, the inner cylindrical surface of channel 13, onto which electrical wire is wound, is formed parallel to the central axis of primary transformer component 3. The operation through which electrical wire is wound onto primary transformer component 3 is simplified due to the inner cylindrical surface of channel 13 being formed parallel with the axial center of transformer 3. This structure provides a significant benefit in terms of the manufacture of primary transformer component 3, especially when the transformer is manufactured through a mass production process in which the electrical wire is mechanically wound around the transformer.

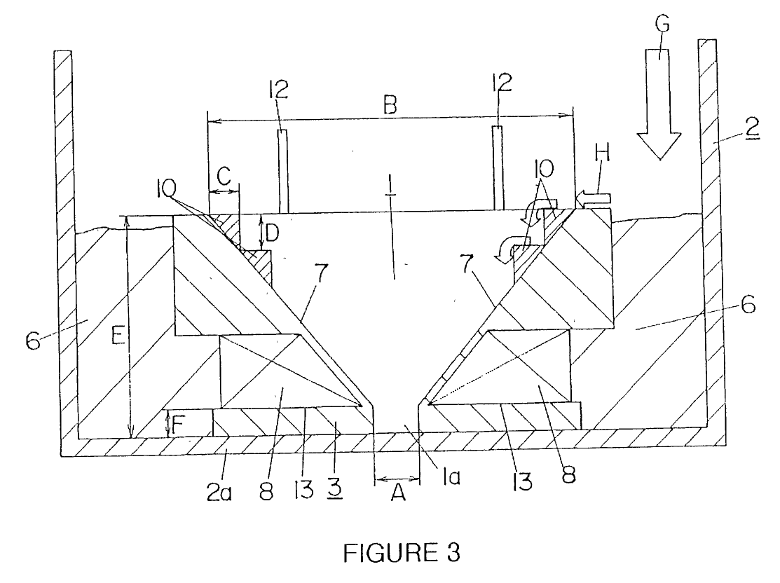

FIG. 3 illustrates a third embodiment of the present invention in which several step portions 10 are formed to various diameters on the wall of core space 1, each step portion 10 being formed at an increasingly larger diameter location of core space 1 extending from the floor of primary housing 2 of primary transformer component 3. In this embodiment, two step portions 10 form a stepped structure that is added to inclined internal wall 7 in proximity to the widely open end of core space 1. With dimension E denoting the height of primary transformer component 3 in the axial direction, and dimension F denoting the distance from the floor of primary housing 2 to primary coil 8 of primary transformer component 3, dimension D, which denotes the height of each step 10, is calculated as D≦(B−A)/4. Furthermore, width dimension C of each step portion 10 is calculated as C≦(E−F)/2. The addition of step portions 10 into core space 1 has the effect of further slowing the already slow flow of resin 6 from the widely open end to floor 1a . By slowing the flow of resin 6 to floor 1a of core space 1, more time is provided for air to escape from core space 1 to further reduce the chances of residual air 15 becoming entrapped within resin 6. The elimination of trapped air 15 within resin 6 makes it possible to significantly reduce the distortion or breakage of primary housing 2 which would otherwise result from the thermal discharge of primary transformer component 3 expanding residual air 15.

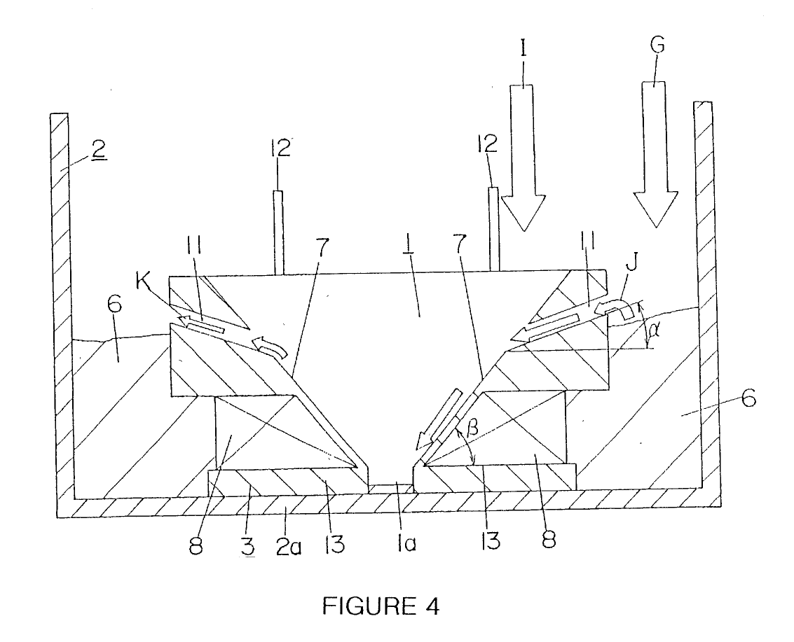

FIG. 4 illustrates a fourth embodiment of the present invention in which open bore 11, which is formed having a diameter smaller than the diameter of core space 1, runs through primary transformer component 3 to connect to core space 1. In this embodiment, open bores 11 may be provided at multiple locations in a radial orientation on primary transformer component 3, and canted downward toward lower surface 2a of primary housing 2 as they approach core space 1. Any appropriate number of bores may be provided. That is, open bores 11 are angled in an upward direction from lower surface 2a of primary housing 2 and extend upward toward the widely open end of core space 1. Furthermore, core space 1 is formed by inclined internal wall 7 as described in the previous embodiments. With the angle of inclined internal wall 7 determined as angle β in relation to lower surface 2a of primary housing 2, and with the angle of open bore 11 determined as angle α also in relation to lower surface 2a of primary housing 2, the relationship between angle β and angle a can be expressed as 0<α<β.

When orifices such as open bores 11 are provided within primary transformer component 3, and when resin 6 is poured into the region between the perimeter of primary transformer component 3 and primary housing 2 (arrow G), resin 6 gradually enters the region between the perimeter of primary transformer component 3 and primary housing 2 and flows through open bores 11 to fill core space 1 (arrow J). Because open bore 11 approaches core space 1 at a downwardly inclined angle toward lower surface 2a of primary housing 2, resin 6 is able to flow smoothly, of its own weight, in a downward direction from open bore 11 to core space 1. Furthermore, because the diameter of open bore 11 is formed to a dimension smaller than that of core space 1, a small amount of resin 6 continues to flow into core space 1 through open bore 11. This structure prevents resin 6 from quickly covering the floor of core space 1 during inflow, thus preventing the conditions under which residual air 15 can become trapped within resin 6.

Even when resin 6 enters primary housing 2 and flows into the widely open end of core space 1 (arrow I), resin 6 still flows slowly from the widely open end of core space 1 down inclined internal wall 7 as a result of inclined internal wall 7 extending from lower surface 2a of primary housing 2 to form an increasingly larger opening to core space 1. Resin 6 does not quickly cover floor 1a of core space 1, thus preventing the conditions under which residual air 15 can become entrapped within resin 6 flowing into core space 1. Even if residual air 15 in core space 1 should become temporarily entrapped within resin 6 while the resin is still in a liquid condition, the air is allowed to escape to the external perimeter of primary transformer component 3 through open bore 11 (arrow K). In other words, open bore 11 also plays a role in bleeding out residual air 15. This structure therefore further reduces the chances of residual air 15 becoming entrapped within resin 6 as resin 6 flows into core space 1.

As described above, open bores 11, which are provided within primary transformer component 3, allow resin 6 to flow smoothly into core space 1 and also allow residual air 15 to escape without becoming entrapped within resin 6 as the resin flows into core space 1. Both of these mechanisms reduce the chances of residual air 15 becoming entrapped within resin 6 as it flows into core space 1.

The several embodiments of the present invention include many advantages. The noncontact transformer of the present invention includes a primary transformer component installed on the floor surface of a primary housing and immersed within resin that fills the primary housing. An inclined internal wall extends outward from the floor of the primary housing to form a gradually widening core space within the primary transformer component, thus allowing resin that flows into the widely open end of the core space to flow smoothly into the core space along the inclined internal wall as a result of the widely open end of the core space being larger than the part of the core space at the floor, during which time the air present in the core space escapes through the widely open end of the core space. As the resin is able to fill the core space without trapping residual air, potential distortion and other damage to the primary housing, which can be caused by the expansion of air trapped within the resin as a result of heat generated by the operating primary transformer component, are thus further prevented.

The noncontact transformer of the present invention also incorporates, in addition, a cylindrical wall formed in parallel to the axial centerline of the primary transformer component with electrical wire being wound around the cylindrical wall to form the primary transformer component coil. This structure makes it easier to wind the electrical wire that comprises the primary coil, thus providing for a simpler and more economical manufacturing process that makes the transformer more adaptable to mass production.

The noncontact transformer of the present invention, in addition, also includes stepped portions formed at various diameters within the core space of the primary transformer component. Providing the stepped portions at specific distances at points of wider opening extending from the floor of the primary housing of the primary transformer component has the effect of reducing the speed of resin flowing from the widely open end of the core space down to the bottom. This structure provides more time for air within the core space to escape and therefore reduces the chances of air within the core space becoming trapped within the resin. Potential distortion and other damage to the primary housing, which can be caused by the expansion of air trapped within the resin as a result of heat generated by the operating primary transformer component, are thus further prevented.

The noncontact transformer of the present invention also includes open bores that are formed within the primary transformer component and oriented so as to connect to the core space, and formed of a diameter less than the diameter of the core space so as to allow resin, which flows into the region between the primary transformer component and primary housing, to flow slowly through the open bores into the core space and to also allow air within the core space to escape in order to prevent air from becoming trapped within the in-flowing resin. Potential distortion and other damage to the primary housing, which can be caused by the expansion of air trapped within the resin as a result of heat generated by the operating primary transformer component, are thus further prevented.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present disclosure relates to subject matter contained in priority Japanese Application No. 2001-280083, filed on Sep. 14, 2001, which is herein expressly incorporated by reference in its entirety.

What is claimed is:

1. A noncontact transformer including a primary transformer component provided within a primary housing and a secondary transformer component provided within a secondary housing, the transformer components being oriented in mutual opposition to induce noncontact electrical power transmission between the primary transformer component and the secondary transformer component through respective primary and secondary coils, wherein the primary transformer component is attached to a lower surface of the primary housing and is immersed in resin filling the primary housing, said noncontact transformer comprising:
an inclined internal wall defining a core space within the primary transformer component, said inclined internal wall extending from the lower surface of the primary housing to an open end, said open end larger than a portion of said core space at the lower surface of the primary housing.

2. The noncontact transformer according to claim 1, wherein the primary transformer component includes a cylindrical surface parallel to the axis of the primary transformer component, and the primary coil of the primary transformer component includes electrical wire wound around said cylindrical surface.

3. The noncontact transformer according to claim 1, further including a plurality of stepped portions provided at various diameters within said core space of the primary transformer component, said stepped portions located at specific distances at points of wider opening extending from the lower surface of the primary housing of the primary transformer component to said open end of said core space.

4. The noncontact transformer according to claim 1, further including a plurality of open bores provided within the primary transformer component, each of said plurality of open bores extending from a cylindrical surface to connect to said core space, each of said open bores having a diameter less than a diameter of said core space.

5. The noncontact transformer according to claim 1, wherein said portion of said core space at the lower end of the primary housing defines a floor having a diameter A and said open end of said core space defines a widely open end having a diameter B, so that:
B>A.

6. The noncontact transformer according to claim 1, wherein said inclined internal wall of said core space is configured substantially in a cone shape extending from the lower surface of the primary housing with an increasing diameter toward said open end.

7. The noncontact transformer according to claim 5, further including a plurality of stepped portions provided at various diameters within said core space of the primary transformer component, said stepped portions located at specific distances at points of wider opening extending from the lower surface of the primary housing of the primary transformer component to said open end of said core space.

8. The noncontact transformer according to claim 7, wherein each of said plurality of stepped portions has a height dimension parallel to the axial direction of the primary transformer component of D, so that:
D≦(B−A)/4.

9. The noncontact transformer according to claim 7, wherein each of said plurality of stepped portions has a dimension perpendicular to the axial direction of the primary transformer component of C, the primary transformer component has a height E in the axial direction of the primary transformer component, and the lower surface of the primary housing and the primary coil are separated by a distance F, so that:
C≦(E−F)/2.

10. The noncontact transformer according to claim 4, wherein each of said plurality of open bores include an internal wall forming a first angle α with the lower surface of the primary housing and said inclined internal wall defining said core space forms a second angle β with the lower surface of the primary housing, so that:
0<αβ.

11. The noncontact transformer according to claim 4, wherein each of said plurality of open bores extends from an external cylindrical surface of the primary transformer component through the primary transformer component toward the lower surface of the primary housing and to said core space, so that each of said plurality of bores is slanted downwardly toward the lower surface of the primary housing.

12. The noncontact transformer according to claim 4, wherein each of said plurality of open bores extends radially from an external cylindrical surface of the primary transformer component through the primary transformer component toward the center of said core space.

13. A primary transformer component for a noncontact transformer, said primary transformer component attached to a lower surface of a primary housing and including a primary coil, said primary transformer component comprising:
an inclined internal wall defining a core space within said primary transformer component, said inclined internal wall extending from the lower surface of the primary housing to an open end, said open end larger than a portion of said core space at the lower surface of the primary housing.

14. The primary transformer component according to claim 13, wherein said primary transformer component includes a cylindrical surface parallel to the axis of said primary transformer component, and the primary coil of said primary transformer component includes electrical wire wound around said cylindrical surface.

15. The primary transformer component according to claim 13, further including a plurality of open bores provided within the primary transformer component, each of said plurality of open bores extending from a cylindrical surface to connect to said core space, each of said open bores having a diameter less than a diameter of said core space.

16. The primary transformer component according to claim 13, wherein said portion of said core space at the lower end of the primary housing defines a floor having a diameter A and said open end of said core space defines a widely open end having a diameter B, so that:
B>A.

17. The primary transformer component according to claim 13, further including a plurality of stepped portions provided at various diameters within said core space of said primary transformer component, said stepped portions located at specific distances at points of wider opening extending from the lower surface of the primary housing of said primary transformer component to said open end of said core space.

18. The primary transformer component according to claim 16, further including a plurality of stepped portions provided at various diameters within said core space of said primary transformer component, said stepped portions located at specific distances at points of wider opening extending from the lower surface of the primary housing of said primary transformer component to said open end of said core space;
wherein each of said plurality of stepped portions has a height dimension parallel to the axial direction of said primary transformer component of D, so that:
D≦(B−A)/4.

19. The primary transformer component according to claim 16, further including a plurality of stepped portions provided at various diameters within said core space of said primary transformer component, said stepped portions located at specific distances at points of wider opening extending from the lower surface of the primary housing of said primary transformer component to said open end of said core space;
wherein each of said plurality of stepped portions has a dimension perpendicular to the axial direction of said primary transformer component of C, said primary transformer component has a height E in the axial direction of said primary transformer component, and the lower surface of the primary housing and the primary coil are separated by a distance F, so that:
C≦(E−F)/2.

20. The primary transformer component according to claim 15, wherein each of said plurality of open bores include an internal wall forming a first angle α with the lower surface of the primary housing and said inclined internal wall defining said core space forms a second angle β with the lower surface of the primary housing, so that:
0<α<β.

21. The primary transformer component according to claim 13, wherein said primary transformer component is immersed in resin filling the primary housing.

22. In combination, a rechargeable electric appliance;
a noncontact transformer; and
a primary transformer component according to claim 13.
